(19) United States
(12) Patent Application Publication
(10) Pub. No.: US 2026/0320420 A1
(43) Pub. Date: Oct. 15, 2026

(54) PROACTIVE RETRIEVAL AUGMENTED GENERATION SYSTEMS FOR MOTIVATING CONTINUOUS DIGITAL ACCESS CONTROL

(71) Applicant: INTERNATIONAL BUSINESS MACHINES CORPORATION, Armonk, NY (US)

(72) Inventors: Paul Henri Muench, San Jose, CA (US); Jonas Alexander Pfefferle, Long Island City, NY (US); Joseph W. Dain, Tucson, AZ (US); Swaminathan Sundararaman, San Jose, CA (US)

(21) Appl. No.: 19/179,594

(22) Filed: Apr. 15, 2025

(51) Int. Cl. G06N 5/022

(52) U.S. Cl. CPC G06N 5/022

(57) ABSTRACT

Systems, methods, and computer program products for proactive retrieval augmented generation (RAG) are disclosed. A method for proactive retrieval augmented generation (RAG) comprises accessing a knowledge database, the knowledge database being configured to monitor changes in underlying data, receiving from the knowledge database an indication of a change in underlying data, updating one or more RAG answers based on the change in underlying data in the knowledge database, and controlling access to RAG answers by a user based on a permission of the user to the knowledge base.

### BACKGROUND

Embodiments of the present disclosure relate to proactive Retrieval Augmented Generation (RAG) systems, and more specifically, to RAG systems that motivate continuous digital access control.

### BRIEF SUMMARY

According to embodiments of the present disclosure, systems, methods, and computer program products for proactive retrieval augmented generation (RAG) are disclosed. A method for proactive retrieval augmented generation (RAG) is provided. The method comprises accessing a knowledge database, the knowledge database being configured to monitor changes in underlying data, receiving from the knowledge database an indication of a change in underlying data, updating one or more RAG answers based on the change in underlying data in the knowledge database, and controlling access to RAG answers by a user based on a permission of the user to the knowledge base.

In various embodiments, updating the one or more RAG answers comprises revocation when underlying data relevant to the one or more RAG answers has changed.

In various embodiments, controlling access to RAG answers comprises withdrawal when the user no longer has permission to access underlying data.

In various embodiments, controlling access to RAG answers comprises maintaining RAG answers while the user retains permission to access underlying data.

In various embodiments, the method further comprises providing a lineage of documents and storage data specific content used to generate the RAG answers.

In various embodiments, the knowledge database has a single source of data access control.

In various embodiments, the knowledge database is configured to monitor underlying data by Change Data Capture (CDC), polling, trigger, or webhook methods.

In various embodiments, a system for proactive retrieval augmented generation (RAG) is provided. The system comprises a computing node comprising a computer readable storage medium having program instructions embodied therewith. The program instructions executable by a processor of the computing node to cause the processor to perform a method comprising the following steps. A knowledge database is accessed, the knowledge database being configured to monitor changes in underlying data. An indication of a change in underlying data is received from the knowledge database. One or more RAG answers is updated based on the change in underlying data in the knowledge database. Access to RAG answers is controlled by a user based on a permission of the user to the knowledge base.

In various embodiments, updating the one or more RAG answers comprises revocation when underlying data relevant to the one or more RAG answers has changed.

In various embodiments, controlling access to RAG answers comprises withdrawal when the user no longer has permission to access underlying data.

In various embodiments, controlling access to RAG answers comprises maintaining RAG answers while the user retains permission to access underlying data.

In various embodiments, the method further comprises providing a lineage of documents and storage data specific content used to generate the RAG answers.

In various embodiments, the knowledge database has a single source of data access control.

In various embodiments, the knowledge database is configured to monitor underlying data by Change Data Capture (CDC), polling, trigger, or webhook methods.

In various embodiments, a computer program product for a proactive retrieval augmented generation (RAG) system is provided. The computer program product comprises a computer readable storage medium having program instructions embodied therewith. The program instructions executable by a processor to cause the processor to: access a knowledge database, the knowledge database being configured to monitor changes in underlying data, receive from the knowledge database an indication of a change in underlying data, update one or more RAG answers based on the change in underlying data in the knowledge database, control access to RAG answers by a user based on a permission of the user to the knowledge base.

In various embodiments, updating the one or more RAG answers comprises revocation when underlying data relevant to the one or more RAG answers has changed.

In various embodiments, controlling access to RAG answers comprises withdrawal when the user no longer has permission to access underlying data.

In various embodiments, controlling access to RAG answers comprises maintaining RAG answers while the user retains permission to access underlying data.

In various embodiments, the processor is further caused to provide a lineage of documents and storage data specific content used to generate the RAG answers.

In various embodiments, the knowledge database has a single source of data access control.

In various embodiments, the knowledge database is configured to monitor underlying data by Change Data Capture (CDC), polling, trigger, or webhook methods.

### BRIEF DESCRIPTION OF THE DRAWINGS

FIG. 1 is a block diagram of an exemplary software architecture for a proactive retrieval augmented generation (RAG) system that motivates continuous digital access control.

FIG. 2 is a flow diagram depicting an exemplary method for outdated answer revocation using a proactive Retrieval Augmented Generation (RAG) system, in accordance with one or more embodiments of this disclosure.

FIG. 3 is a flow diagram depicting an exemplary method for proactive retrieval augmented generation (RAG), in accordance with one or more embodiments of this disclosure.

FIG. 4 depicts a computing node suitable for the implementation of a proactive retrieval augmented generation (RAG) system according to one or more embodiments of the present disclosure.

### DETAILED DESCRIPTION

Retrieval Augmented Generation (RAG) systems are a powerful tool in optimizing the generative results of Large Language Models (LLMs). LLMs are typically trained on and rely on large quantities of unrefined, static data to retrieve answers. Because of this and the fact that re-training is often laborious and expensive, LLMs may frequently present inaccurate responses, untruthful information, or data gathered from untrustworthy sources. RAG systems are a possible approach for enhancing the accuracy of generative results by quickly accessing relevant data sources without the need to retrain an LLM. For example, RAG systems may be integrated with LLMs to provide users answers based on real time news and new research. These features are particularly useful in LLM applications such as chatbots used by employees of a company, researchers of a specific organization, lay people, or any group where information and data is constantly changing.

Although the purpose of RAG systems is to provide answers based on continuously updated data, users of the RAG system can be operating on outdated answers without knowing the answers are outdated. Prior answers can become obsolete as new data is added or old data is changed. This may be an especially prominent issue for LLMs used in organizations where new research and/or projects are constantly being executed. Although users can repeat queries on a periodic basis, because users have no knowledge of when data will change, a multitude of users and a multitude of queries per user would put an excessive, unproductive load on a RAG system.

Furthermore, in instances where LLMs are being used in organizations by members who have differing roles and access to different types of data, LLMs can accidentally provide sensitive information to users who should not have access to said data.

Thus, there exists a need in the art to provide a method for a proactive RAG system capable of continuously managing a domain database and preemptively providing updated information to appropriate users.

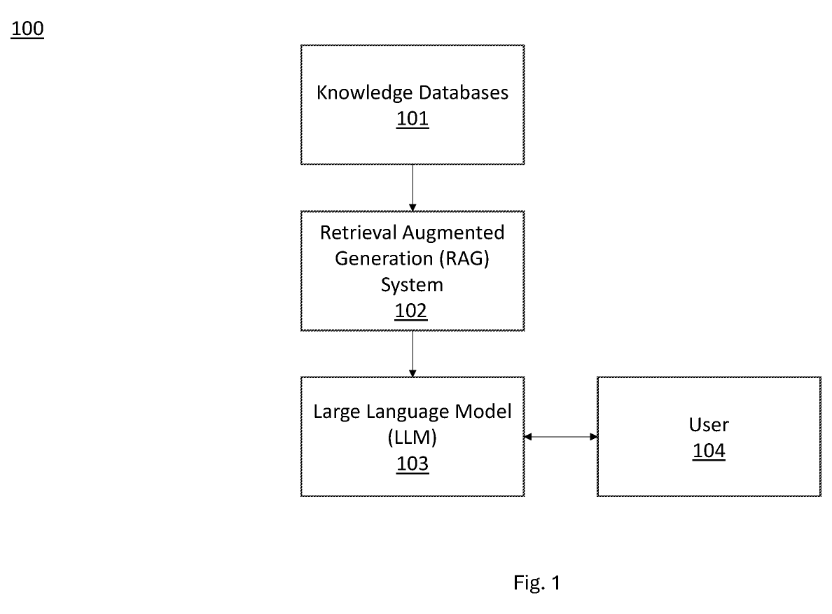

Referring now to FIG. 1 a block diagram of an exemplary software structure 100 underlying a method for a proactive retrieval augmented generation (RAG) system that motivates continuous digital access control is depicted.

As shown in FIG. 1, the software architecture for a proactive retrieval augmented generation (RAG) system that motivates continuous digital access control includes a RAG system 102 capable of enhancing a Large Language Model (LLM) 103. The RAG system 102 may be operably connected to the LLM 103. For example, the RAG system 102 may be capable of passing answer information to the LLM 103. The software structure may also include a knowledge database 101. The knowledge database 101 may contain information relevant to answers questions posed by a user 104. The knowledge database 101 may be continuously updated as new information is available. For example, recent news events, new research, and current publications may all be used to update the knowledge database 101. Further, the knowledge base 101 may be capable of monitoring when data changes or is added.

In various embodiments, the LLM 103 may be embodied in the form of a chatbot. In various embodiments, the LLM 103 may be embodied in the form of an automated contention creation tool, a text summarization tool, or sentiment analysis tool. In various embodiments, the LLM 103 may be embodied in any suitable form.

In operation, a user 104 may interface with an LLM 103 and ask various questions. For example, a user may routinely ask an LLM 103 for restaurant recommendations. The RAG system may access data in a knowledge database 101 specific to answering the user’s 104 query. The RAG system 102 may access a map of restaurants in areas close to the user 104 in the knowledge database 101. This information may be provided by the RAG system 102 to the LLM 103 to be used in providing answers for the user 104. However, as discussed, data stored in the knowledge database may be subject to change, deletion, or additions. Continuing the example, restaurants in an area close to a user 104 may shut down, move, or new restaurants may arise.

In such situations, the knowledge database 101 may be capable of recognizing those changes. The knowledge database 101 may be capable of driving the RAG system 102 with the updated data. In other words, the RAG system 102 may provide updated data and answers to the LLM 103 to generate answers, such as restaurant recommendations, to the user 104.

In various embodiments, the knowledge database 101 may include a single source of data access control and may be capable of monitoring itself for changes, deletions, and/or additions of data. In various embodiments, the knowledge database 101 is capable of doing so by employing Change Data Capture (CDC), polling, trigger, or webhook methods. In various embodiments, the knowledge database 101 may implement any suitable method for ensuring that changes, deletions, and/or additions are monitored.

In various embodiments, the knowledge database 101 may include publications, web articles, maps, real-time news, past news, camera footage. In various embodiments, the knowledge database may contain any relevant information required by an LLM. In various embodiments, the RAG system may be capable of monitoring changes from various sources. For example, the knowledge database 101 may include various types of information which may come from different sources (e.g., news outlets, scientific journals, corporate databases), and may be capable of monitoring changes regardless of which source causes a change in the information stored in the knowledge database 101.

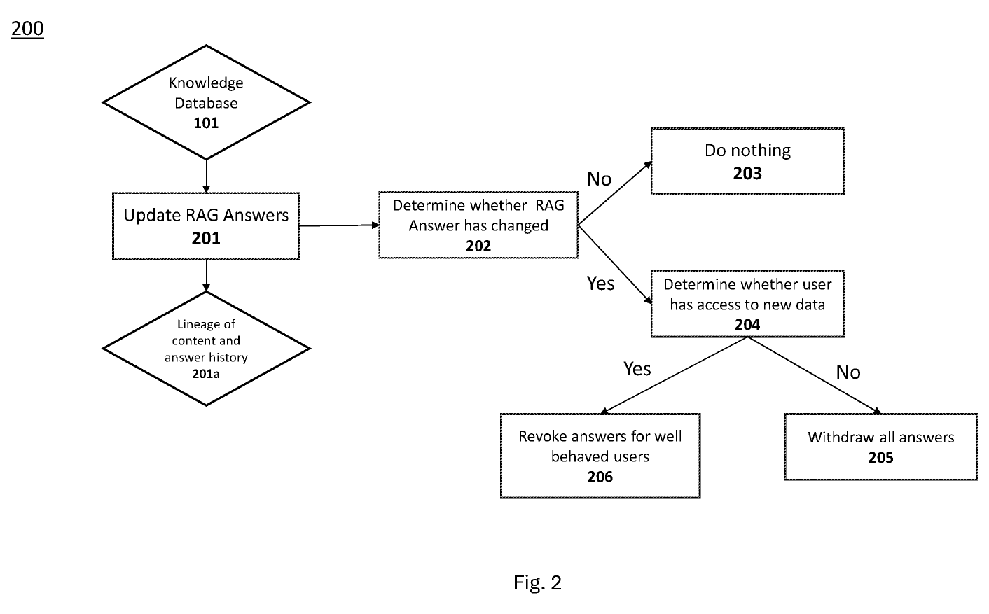

Referring now to FIG. 2 a flow diagram depicting an exemplary method for outdated answer revocation using a Retrieval Augmented Generation (RAG) system is depicted. In this example, a knowledge database 101 provides a RAG system with updated data. Based on the received information, the RAG system may update answers to questions when prompted by a user at step 201. The RAG system may then perform a check to determine whether the answers to the query provided by the user have changed at step 202. When the data provided by the knowledge database has not been changed or has changed in such a way that it affects the information provided to a user by an LLM, the RAG system may not initiate any changes and provide the same information to the LLM and to the user at step 203. In various embodiments, as long as the RAG system continues to have access to the information on which an answer depends on, it may maintain an answer. For example, a company may change its access settings for certain data and deem it private to everybody, including RAG and LLM systems. However, as long as the data is accessible by the RAG system, it may continue to provide it to the LLM and user.

Conversely, when the RAG system determines that the changes, additions, and/or deletions to the database do affect the information provided to a user by an LLM, the RAG system may determine whether the user has access to the new data at step 204. For example, an LLM, such as a chatbot, used internally within a company may rely on information stored in internal, private company knowledge databases. New information may be added to a corporate knowledge database by various teams working on various projects who do not necessarily collaborate or share information with each other. Thus, when a user provides a query to an LLM connected to the proactive RAG system described herein, the system may determine whether the user providing the query has access to the new data that affects the information included in the answer. Continuing the example, a member of the marketing team of a company may not have access to information and projects handled by the engineering team of the same company and vice versa. Therefore, the RAG system may need to determine whether a user is authorized to have access to information created within the engineering or marketing team.

When the RAG system and knowledge database determine that the user does not have access to the new data stored in the knowledge database, all answers and/or information may be withdrawn from the user at step 205. For example, when an employee of the marketing team requests an answer to a question related to information produced within the engineering team, the LLM supplemented by the proactive RAG system may withdraw any answers to the marketing employee. In other non-limiting examples, the RAG system may withdraw information for answers when deemed that the information is sensitive or private.

The RAG system may determine whether users have access to data by a variety of means. In various embodiments, the system may be configured to recognize the identity of the user providing a query. For example, in various embodiments, the system may operate only when a user is signed into a company account which is synced with information related to their title, department, background, company designated information access levels (e.g. how much and which information the employee is authorized to have access to).

In various embodiments, the LLM may be capable of predicting or guessing a user’s identity. For example, for chatbots being used by families or in schools, an LLM may be configured to guess whether a user is a child in order to restrict a child from accessing age-inappropriate information. In various embodiments, the RAG system may use established data access control methods such as Discretionary Access Control (DAC), Mandatory Access Control (MAC), Role-Based Access Control (RBAC), and/or Attribute-Based Access Control (ABAC) methods.

In various embodiments, the RAG system may include a single source/method of data access control. In various embodiments, the RAG system may include a multiple sources/methods of data access control.

When the RAG system and knowledge database determine that the user does have access to the new data stored in the knowledge database, it may revoke answers based on outdated or incorrect information in a reliable fashion as long as the user is well-behaved at step 206. A well-behaved user may be defined as one who phrases queries in a clear manner (e.g. in a manner that is understandable for an LLM). Answers are revoked when they are determined to be outdated, incorrect, or when the user lacks permission to the information relevant to the question asked.

In various embodiments, when the RAG system determines that the user does not have access to the new data, the LLM may output an error message in response to a question or request. In various embodiments, when the RAG system determines that the user does not have access to the new data, the LLM may display a message to the user that they do not have access to the new data in response to a question or request.

As answers and information are updated throughout the process, a lineage of content and answer history is generated at step 201a and stored in the knowledge database. For example, and without limitation, the LLM may store a question-and-answer chat history which a user can view at later times. In various embodiments, when answers should be revoked, the LLM may also remove said answers from the answer history such that they are no longer accessible to a user (in addition to revoking answers as questions are asked).

Prior, outdated answers are also maintained in the knowledge database. Doing so enables the RAG system and LLM to compare past answers with current answers, providing an additional layer of verification as to whether new, changed, or deleted data would affect information displayed to the user.

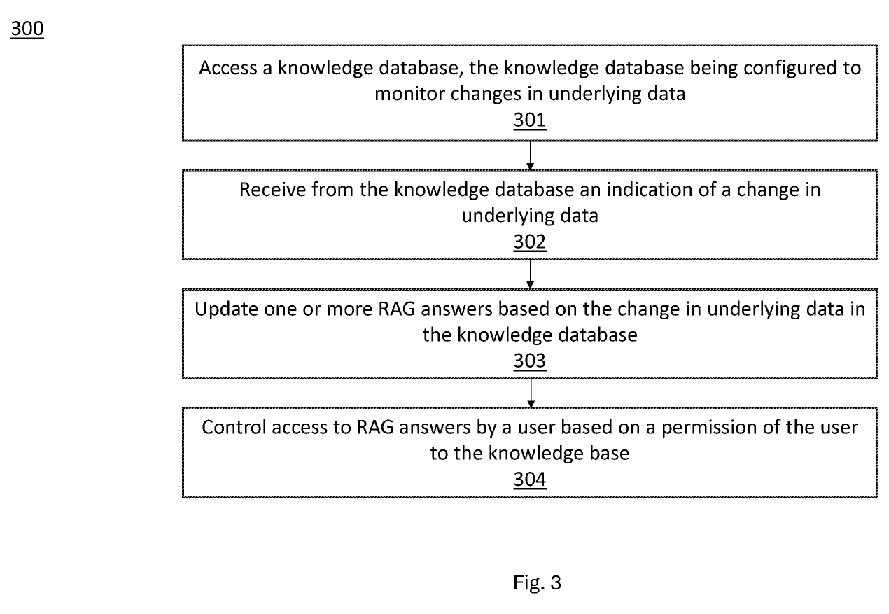

Referring now to FIG. 3, a flow diagram depicting an exemplary method 300 for proactive retrieval augmented generation (RAG) is depicted. At step 301, a knowledge database is accessed, the knowledge database being configured to monitor changes in underlying data. At step 302, an indication of a change in underlying data is received from the knowledge database. At step 303, one or more RAG answers is updated based on the change in underlying data in the knowledge database. At step 304, access to RAG answers by a user is controlled based on a permission of the user to the knowledge base.

The operations of the methods presented above are intended to be illustrative. In various embodiments, the methods described above are accomplished with one or more additional operations not described and/or without one or more of the operations discussed. The operations of the methods described above may be performed in another order. Additionally, the order in which the operations of methods illustrated in FIG. 1-3 and described above are not intended to be limiting.

In various embodiments, the methods described above are implemented in one or more processing devices (e.g., a digital processor, an analog processor, a digital circuit designed to process information, a state machine, and/or other mechanisms for electronically processing information). The one or more processing devices may include one or more devices configured through hardware, firmware, and/or software to be specifically designed for execution of one or more of the operations of the methods described above.

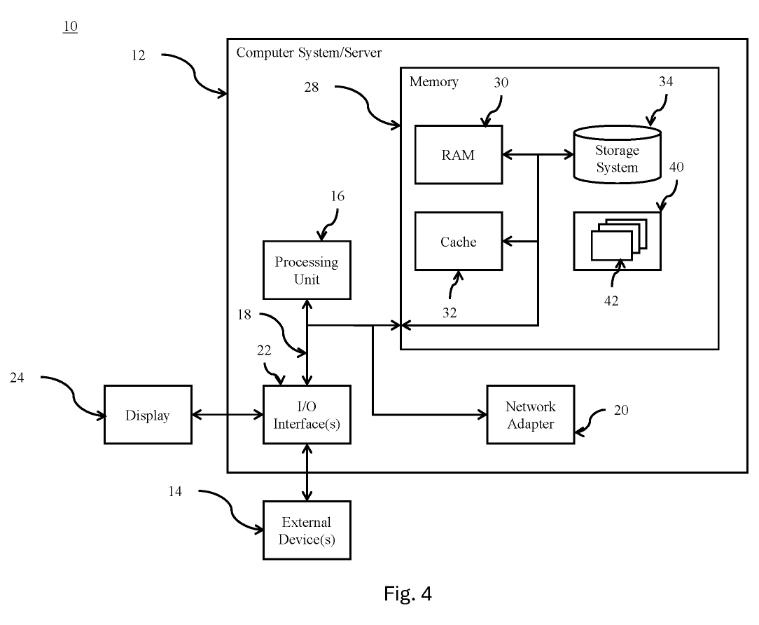

Referring now to FIG. 4, a computing node 10 suitable for the implementation of a proactive retrieval augmented generation (RAG) system is depicted. As shown in FIG. 4, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a "hard drive"). Although not shown, a magnetic disk drive for reading from and writing to a removable, non-volatile magnetic disk (e.g., a "floppy disk"), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In various embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for proactive retrieval augmented generation (RAG), the method comprising:
accessing a knowledge database, the knowledge database being configured to monitor changes in underlying data;
receiving from the knowledge database an indication of a change in underlying data;
updating one or more RAG answers based on the change in underlying data in the knowledge database;
controlling access to RAG answers by a user based on a permission of the user to the knowledge base.

2. The method of claim 1, wherein updating the one or more RAG answers comprises revocation when underlying data relevant to the one or more RAG answers has changed.

3. The method of claim 1, wherein controlling access to RAG answers comprises withdrawal when the user no longer has permission to access underlying data.

4. The method of claim 1, wherein controlling access to RAG answers comprises maintaining RAG answers while the user retains permission to access underlying data.

5. The method of claim 4, further comprising: providing a lineage of documents and storage data specific content used to generate the RAG answers.

6. The method of claim 1, wherein the knowledge database has a single source of data access control.

7. The method of claim 1, wherein the knowledge database is configured to monitor underlying data by Change Data Capture (CDC), polling, trigger, or webhook methods.

8. A system for proactive retrieval augmented generation (RAG) comprising:
a computing node comprising a computer readable storage medium having program instructions embodied therewith, the program instructions executable by a processor of the computing node to cause the processor to perform a method comprising:
accessing a knowledge database, the knowledge database being configured to monitor changes in underlying data;
receiving from the knowledge database an indication of a change in underlying data;
updating one or more RAG answers based on the change in underlying data in the knowledge database;
controlling access to RAG answers by a user based on a permission of the user to the knowledge base.

9. The system of claim 8, wherein updating the one or more RAG answers comprises revocation when underlying data relevant to the one or more RAG answers has changed.

10. The system of claim 8, wherein controlling access to RAG answers comprises withdrawal when the user no longer has permission to access underlying data.

11. The system of claim 8, wherein controlling access to RAG answers comprises maintaining RAG answers while the user retains permission to access underlying data.

12. The system of claim 11, the method further comprising: providing a lineage of documents and storage data specific content used to generate the RAG answers.

13. The system of claim 8, wherein the knowledge database has a single source of data access control.

14. The system of claim 8, wherein the knowledge database is configured to monitor underlying data by Change Data Capture (CDC), polling, trigger, or webhook methods.

15. A computer program product for proactive retrieval augmented generation (RAG), the computer program product comprising a computer readable storage medium having program instructions embodied therewith, the program instructions executable by a processor to cause the processor to:
access a knowledge database, the knowledge database being configured to monitor changes in underlying data;
receive from the knowledge database an indication of a change in underlying data;
update one or more RAG answers based on the change in underlying data in the knowledge database;
control access to RAG answers by a user based on a permission of the user to the knowledge base.

16. The computer program product of claim 15, wherein updating the one or more RAG answers comprises revocation when underlying data relevant to the one or more RAG answers has changed.

17. The computer program product of claim 15, wherein controlling access to RAG answers comprises withdrawal when the user no longer has permission to access underlying data.

18. The computer program product of claim 15, wherein controlling access to RAG answers comprises maintaining RAG answers while the user retains permission to access underlying data.

19. The computer program product of claim 18, further causing the processor to: provide a lineage of documents and storage data specific content used to generate the RAG answers.

20. The computer program product of claim 15, wherein the knowledge database has a single source of data access control.

21. The computer program product of claim 15, wherein the knowledge database is configured to monitor underlying data by Change Data Capture (CDC), polling, trigger, or webhook methods.
